(19) United States
(12) Patent Application Publication
(10) Pub. No.: US 2009/0128057 A1
(43) Pub. Date: May 21, 2009

(54) FLUORESCENT LAMP AND BALLAST WITH BALANCED ENERGY RECOVERY PUMP

(76) Inventor: Frank Alexander Valdez, San Mateo, CA (US)

Correspondence Address: DAVID E. LOVEJOY, REG. NO. 22,748, 102 REED RANCH ROAD, TIBURON, CA, 94920-2025, US

(21) Appl. No.: 12/210,217

(22) Filed: Sep. 15, 2008

Related U.S. Application Data
(60) Provisional application No. 60/972,755, filed on Sep. 15, 2007.

(51) Int. Cl. H05B 41/00

(52) U.S. Cl. 315/307

(57) ABSTRACT

A fluorescent lamp formed of a power control unit and a fluorescent lamp assembly. The lamp assembly includes a fluorescent tube having filaments and including inductive and capacitive components connect to the filaments forming a resonant network. The power control unit includes an input power unit, an energy recovery pump, a bulk capacitor and a lamp driver including a half-bridge power stage and a half-bridge driver. The input power unit provides an input voltage, includes a lamp driver for switching a high DC voltage with a high switching frequency to provide a high-frequency driving voltage for driving the resonant network. The energy recovery pump is balanced so as not to disturb the resonance of the network and so as to enable recovery and transfer of energy to the bulk capacitor and thereby establish a high luminous efficiency for the fluorescent lamp.

### CROSS-REFERENCED APPLICATIONS

This application claims the benefit under 35 USC 119(e) of Provisional Patent Application U.S. Ser. No. 60/972,755 entitled FLUORESCENT LAMP AND BALLAST WITH ENERGY COMBINATION PUMP, filed Sep. 15, 2007; First Named Inventor Frank A. Valdez. Application Ser. No. 60/972,755 is hereby incorporated by reference in its entirety in the present specification.

### TECHNICAL FIELD

The present invention relates generally to fluorescent lights including Compact Fluorescent Lamps (CFL's), long fluorescent lamps and other fluorescent lamps.

### BACKGROUND OF THE INVENTION

Incandescent lights for many years have been widely deployed for lighting in homes, industries and businesses of all kinds. The need for conservation of energy makes fluorescent lights increasingly important. Fluorescent lights greatly reduce energy consumption when compared to incandescent lights with equivalent light producing capacity.

A fluorescent light is a gas discharge device that converts electrical energy into visible light with high efficiency. A fluorescent light includes a glass tube, usually filled with low-pressure mercury vapor, having electrodes at each end. Each electrode is typically formed from a resistive filament such as tungsten coated with a thermionically emissive material such as alkaline earth oxides.

In operation of a typical fluorescent light, a voltage is applied across the resistive filaments, heating the electrodes to a temperature sufficient to cause thermionic emission of electrons into the discharge tube. A voltage applied between the electrodes accelerates the electrons from the cathode toward the anode and the electrons collide with gas atoms to produce positive ions, in the ultra-violet (UV) spectra range, and additional electrons forming a UV gas plasma of positive and negative charge carriers sustaining an electric discharge in the tube. With AC applied power, the electrodes reverse polarity each half cycle.

The discharge in the fluorescent tube causes the emission of radiation having a wavelength dependent upon the particular gas in the tube and the electrical parameters of the discharge. A phosphor coating on the inside surface of the glass tube is excited by ultra-violet (UV) radiation from the discharge to provide the visible light output.

Fluorescent lamps are available in different sizes and shapes. Elongated Fluorescent Lamps (EFLs) are formed of straight or curved elongated tubes generally of circular cross section with varying outside diameters typically ranging between about five-eighths and one and one-half inches. In general, the longer the tubes, the higher the voltage required for operation. Generally, about 100 volts per foot are required so that for a four foot tube about 400 volts peak-to-peak are required.

Compact Fluorescent Lamps (CFL's) are formed of tubes generally of circular cross section with varying outside diameters typically of less than about five-eighths of an inch and having one or more small radius bends so that the tubes compactly fold back upon themselves.

Power control units are required to control the current and voltage between the electrodes to provide stable operation of fluorescent lights. Power control units typically include an input power unit, a bulk capacitor and a lamp driver composed of a half-bridge power stage and a half-bridge driver circuit.

The input power unit receives the AC power line input, either directly or through a dimmer, and operates to provide a full-wave rectified input voltage. The voltage on the bulk capacitor is used as an energy source for the half-bridge power stage. The half-bridge power stage provides a high-voltage, high-frequency square-wave for driving the resonant network of the lamp assembly.

The fluorescent lamp assembly includes a resonant network formed with a resonant inductor, L, and a resonant capacitor, C, connected to the filaments of the fluorescent tube. The half-bridge power stage drives the resonant network with a high-frequency (for example, about 50 kHz) AC drive voltage causing a resonant oscillation in the resonant network that drives a resonant current through the fluorescent tube to generate the fluorescent light. A DC-blocking capacitor, C₂, connects the resonant network to ground to allow the resonant voltage to float above ground. The DC-blocking capacitor typically has a capacitance value ten or more times greater than the value of the resonant capacitor, C, so as not to affect the resonant frequency of resonant network formed by the resonant inductor, L, and a resonant capacitor, C.

One typical resonant network is described by STMicro in an AN880 Application Note entitled “The L6569: A NEW HIGH VOLTAGE DRIVER FOR ELECTRONIC LAMP BALLAST”. In that application note, the lamp driver is the STMicro L6569 High Voltage IC Driver which is an integrated circuit for driving an external half-bridge power stage. The application note describes the use of a DC-blocking capacitor of 100 nF and a resonant capacitor of 4.1 nF so that the blocking capacitor is approximates 24 times greater than the value of the resonant capacitor. In a typical operation of the L6569 High Voltage IC Driver integrated circuit, the resonant network operates with a 20 V peak-to-peak sine wave centered upon a +55 VDC voltage level at the top of the DC blocking capacitor. The DC-blocking capacitor operates to allow the voltage level on the resonant capacitor, C, to float on top of the +55 VDC voltage level.

Another resonant network for controlling compact fluorescent lamps is described in the International Rectifier Data Sheet No PD60062 for the IR2153 SELF-OSCILLATING HALF-BRIDGE DRIVER.

Another resonant network for controlling compact fluorescent lamps is described in the Fairchild publication “FAN7710, Ballast Control IC for Compact Florescent Lamps” published in June of 2007. In the Fairchild FAN7710 lamp driver, MOSFET switching transistors constituting the half-bridge power stage are included internally within the integrated circuit in a common package.

Many integrated circuit and non-integrated circuit embodiments of fluorescent lamp power control units and lamp drivers are known in the prior art. The performance of these power control units and the value they bring to reducing energy consumption is evaluated with respect to many factors including power efficiency, power factor (PF), component cost, thermal efficiency and size.

Power efficiency is measured as light output (lumens) as a function of power used (watts). For incandescent lamps, by way of example, typically 75 watts is required for 1200 lumens (16 lumens/watt) and 100 watts are required for 1600 lumens (16 lumens/watt).

In currently available compact fluorescent lamps, by way of typical examples, approximately 19 watts are used for 1200 lumens (63 lumens/watt) and use approximately 23 watts for 1600 lumens (70 lumens/watt). Compact florescent lamps have significantly improved power efficiency relative to incandescent lamps, typically about four or more times greater efficiency than the incandescent lamps they replace.

Power factor (PF) is defined as real power divided by apparent power. The phase relationship between an input line voltage and an input line current is a measure of the power factor. In a load with a power factor of 1, the phase relation between the input line voltage and the input line current is zero degrees, that is, they are in phase. The utility companies supply customers with power measured in volt-amperes and historically have only billed customers for real power (watts). Power companies today increasingly are charging more for poor power factor loads. When the power factor is 1, the volt-amperes and watts are the same. However, with power factors below 1.0, utilities must generate, apparent power, with greater volt-amperes to supply the real power measured in watts. This increase in volt-amperes, apparent power, correspondingly increases generation and transmission costs for the utilities and reduces the overall efficiency of the power supply system.

Incandescent lamps are ideal when analyzed with respect to power factor since in steady-state operation they are purely resistive and have a power factor of 1. By way of contrast, compact fluorescent lamps employ resistive, inductive and capacitive components that adversely reduce the power factor and hence reduce the benefit that is otherwise attributable to compact fluorescent lamps. Currently available compact fluorescent lamps have power factors that, in typical examples, are poor values less than 0.6.

Compact fluorescent lamps are desirably small in size with dimensions that are acceptable when contrasted with the dimensions of the incandescent bulbs that they replace. For example, one typical 1600 lumens compact fluorescent lamp has an Edison screw base with a base cup diameter of about 1.8 inches, a base cup height of about 1 inch, a glass spiral diameter of about 2.4 inches and an overall height of about 3.7 inches. Similarly, one typical 1200 lumens compact fluorescent lamp has an Edison screw base with a cup diameter of about 1.7 inches, a base cup height of about 0.9 inch, a glass spiral diameter of about 2.4 inches and an overall height of about 3.2 inches. For these typical dimensions, the electronic components must fit within a base cup volume of less than about 2.5 in³.

Compact fluorescent lamps with small base cup volumes, such as less than about 2.5 in³ for a 1600 lumens lamp, must be able to dissipate the heat generated by the electronic circuitry within the base cup. The heat generated by a compact fluorescent lamp is split between the heat generated in the fluorescent tubes external to the base cup and the heat generated by the electronic circuitry within the base cup. If the heat within the base cup of a compact fluorescent lamp is not adequately dissipated, the temperature of the components within the cup may excessively rise and prevent proper operation of or destroy the compact fluorescent lamp.

Compact fluorescent lamps with small base cup volumes, must be able to contain the electronic components of the lamp. As the parameters of components change, the sizes of the components change. For example, as the capacitance value of a capacitor increases, the physical size of the capacitor typically increases. Similarly, as the inductance of an inductor increases, the physical size of the inductor typically increases.

Compact fluorescent lamps (CFL) that are attractive alternatives to the incandescent bulbs they replace are needed. Such compact fluorescent lamps along with small size and low cost require improved performance with a balance among power efficiency, power factor (PF), heat dissipation, size and other parameters.

In consideration of the above background, there is a need for improved fluorescent lamps which are easily and readily useable in place of standard incandescent lights, and which operate with energy efficiency, which are economical to manufacture and which operate with a high power factor and high energy efficiency.

### SUMMARY

A fluorescent lamp is formed by a lamp assembly and a power control unit. The lamp assembly includes a fluorescent tube having filaments and includes a resonant network, having resonant inductance and resonant capacitance values, connected to the filaments for resonant operation. The power control unit drives the lamp assembly and includes an input power unit for providing an input voltage, a bulk capacitor for storing a high DC voltage, a lamp driver for switching the high DC voltage with a high switching frequency to provide a high-frequency driving voltage for driving the resonant network, a source for providing an additional voltage, and an an energy recovery pump. The energy recovery pump combines the input voltage and the additional voltage to form the high DC voltage. The energy recovery pump is balanced so as not to disturb the resonant operation of the resonant network and so as to enable transfer of energy to the bulk capacitor to provide a high luminous efficiency for the fluorescent lamp.

The energy recovery pump includes a first pump element for unidirectional conduction of an input current in response to the input voltage, a second pump element connected at a pump node with the first pump element for unidirectional conduction of a charging current to charge the bulk capacitor. A pump control connects the additional voltage to the pump node to cause an input current (i) to conduct through the first pump element and the second pump element to charge the bulk capacitor when the input voltage is greater than a voltage threshold and (ii) to cause the first element to be non-conducting and to cause an additional current to conduct through the second pump element to charge the bulk capacitor when the input voltage is less than the voltage threshold.

In one preferred embodiment, the pump elements are diodes and the pump control is implemented with diodes and capacitors. In another embodiment, the pump elements and pump control are a combination of diodes and capacitors.

In one preferred embodiment, the pump control comprises a first pump control element including a first unidirectional control element and a first capacitor connected between a control node and the pump node and a second pump control element including a second unidirectional control element and a second capacitor connected between a reference level and the control node. The additional voltage is connected at the control node.

The fluorescent lamp of claim 4 wherein the first capacitor has a value that is more than about ten times greater than a value of the second capacitor and wherein the value of the second capacitor is about five times greater than the resonant capacitance value.

In typical embodiments, the lamp driver includes a half-bridge power stage for switching the high DC voltage and a half-bridge driver providing the high switching frequency to the half-bridge power stage. Typically, the half-bridge power stage includes a first transistor and a second transistor connected in series and the half-bridge driver alternately switches the first transistor and the second transistor ON and OFF whereby the first transistor is ON when the second transistor is OFF and whereby the first transistor is OFF when the second transistor is ON. In one embodiment, the half-bridge driver includes an integrated circuit driver for driving the half-bridge power stage in multiple power modes including a start-up mode and a steady-state mode.

In one preferred embodiment, the first transistor and the second transistor are MOSFET transistors having source-to-drain connections in series and the half-bridge driver is an integrated circuit having first and second outputs connected to gates of the first transistor and the second transistor, respectively, for controlling the ON and OFF switching of the first transistor and the second transistor.

In one preferred embodiment, the lamp driver includes a half-bridge power stage for switching the high DC voltage and a half-bridge driver providing the high switching frequency to the half-bridge power stage and where the half-bridge power stage and the half-bridge driver are integrated into a common monolithic integrated circuit package.

The foregoing and other objects, features and advantages of the invention will be apparent from the following detailed description in conjunction with the drawings.

### BRIEF DESCRIPTION OF THE DRAWINGS

FIG. 1 is a block diagram of a fluorescent lamp including a fluorescent lamp assembly powered by a power control unit.

FIG. 2 depicts a block and schematic diagram of the energy recovery pump within the power control unit of FIG. 1.

FIG. 3 depicts a detailed block and circuit diagram of one embodiment, using diodes, of the power control unit and lamp assembly of FIG. 1.

FIG. 4 depicts a detailed block and circuit diagram of the embodiment of the power control unit and lamp assembly of FIG. 3 with an integrated circuit half-bridge driver in the power control unit.

FIG. 5 depicts details of a driver control used in the half-bridge driver of FIG. 3.

FIG. 6 depicts a MOSFET embodiment of the energy recovery pump of FIG. 2.

FIG. 7 depicts a detailed block and circuit diagram of a self-oscillating, transformer power stage driver embodiment of the fluorescent lamp of FIG. 1, using bipolar transistors in the half-bridge stage and having a conventional triac dimmer in series with the input line voltage.

FIG. 8 depicts a detailed block and circuit diagram of an integrated circuit and transformer power stage driver embodiment of the fluorescent lamp of FIG. 1 with a high voltage high-side transformer.

FIG. 9 depicts a detailed block and circuit diagram of a power integrated circuit power stage driver embodiment of the fluorescent lamp of FIG. 1 wherein the half-bridge power stage is included inside the integrated circuit.

FIG. 10 depicts a 60 Hz waveform representing the input power voltage.

FIG. 11 depicts a waveform representing the full-wave rectified input power voltage.

FIG. 12 depicts a 50 kHz waveform representing the drive voltage for driving the lamp assembly and representing the output of the half-bridge power stage.

FIG. 13 depicts a 50 kHz waveform representing the drive voltage at the filament in the lamp assembly.

FIG. 14 depicts a 50 kHz waveform representing the energy recovery voltage from the lamp assembly.

FIG. 15 depicts a combination of a waveform derived from the 60 Hz input voltage and a waveform derived from a 50 kHz voltage at a node in the energy recovery pump.

FIG. 16 depicts a waveform of a 60 Hz voltage representing the input voltage from a power dimming triac considered as either no-dimming with no phase chopping (including both the solid portion and the shaded portion) or as full dimming with 90 degree phase chopping (including only the solid portion).

FIG. 17 depicts the waveform of the voltage of FIG. 16 full-wave rectified.

FIG. 18 depicts a 50 kHz waveform representing the drive voltage at the filament in the lamp assembly.

FIG. 19 depicts the 60 Hz derived full-wave rectified waveform of FIG. 17 combined with a 50 kHz derived waveform for both the no-dimming with no phase chopping and the full dimming with 90 degree phase chopping at the pump node.

FIG. 20 depicts an actual input voltage, Vin, at a full-wave rectifier node for 120 Vrms and 220 Vrms input line voltages.

FIG. 21 depicts an actual energy recovery pump voltage, Vcomb, at a pump node 125 that establishes the voltage threshold.

FIG. 22 depicts the output voltage on the bulk capacitor including voltage ripple, for both 120 Vrms and 220 Vrms input line voltages, which follows closely the combination voltage and therefore which also establishes the voltage threshold.

FIG. 23 depicts the fluorescent lamp of FIG. 1, typically a compact florescent light (CFL), contained within a housing having an Edison-type base for engaging conventional Edison light fixtures.

FIG. 24 depicts the fluorescent lamp of FIG. 1, typically, a 4-foot long fluorescent lamp (LFL).

### DETAILED DESCRIPTION

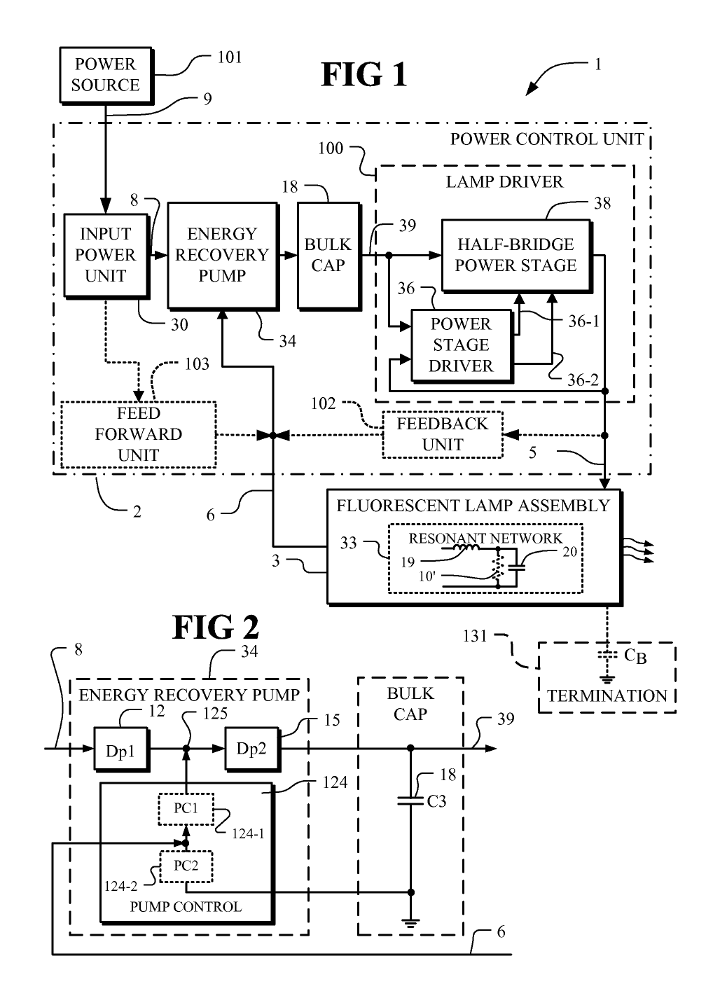

In FIG. 1, the fluorescent lamp 1 includes a power control unit 2 and a fluorescent lamp assembly 3. The power control unit 2 includes an input power unit 30, an energy recovery pump (ERP) 34, a bulk capacitor 18 and a lamp driver 100 including a half-bridge power stage 38 and a half-bridge driver 36. The fluorescent lamp assembly 3 includes a resonant network 33. The resonant network 33 is shown schematically including an inductor 19, a resonant capacitor 20 and a resistive impedance 10′ (representing a fluorescent tube). The energy recovery pump 34 is balanced so as not to disturb the resonance of the network 33 and so as to enable recovery and transfer of energy to bulk capacitor 18 and thereby establish a high luminous efficiency (lumens/watt) for the fluorescent lamp 1.

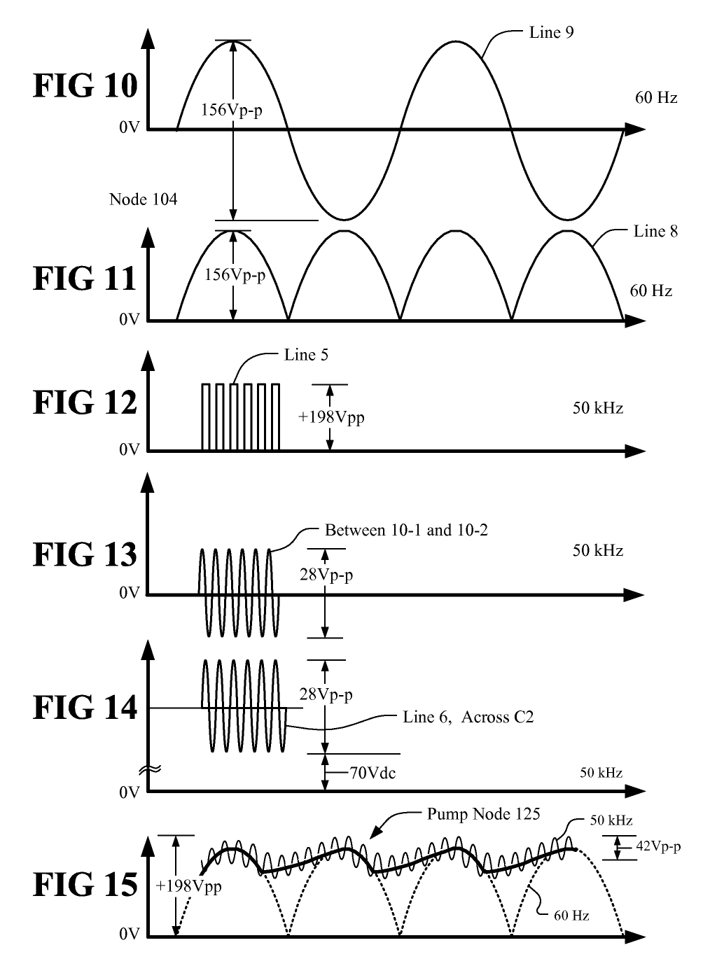

In the power control unit 2 of FIG. 1, the input power unit 30 receives low-frequency AC power on lines 9. The input voltage, Vline, on line 9 typically is nominally 110 Vrms or 220 Vrms, 60 Hz sinusoidal line voltage. Actual line voltages vary over ranges above and below the nominal values (for example, from 80 Vrms to 140 Vrms for nominal 110 Vrms) and have different values in other countries of the world. The input power unit 30 operates to receive the input Vline on lines 9 (for example, 156 volts peak-to-peak, Vp-p, for a 110 Vrms input, see FIG. 10) to provide a full-wave rectified voltage on line 8 (nominally about 156 Vp-p) and is subsequently converted to a DC level (nominally about 198 Vdc) in the energy recovery pump 34.

In FIG. 1, the energy recovery pump 34 pumps the rectified input voltage, Vin, on line 8 to a combined voltage, Vcomb, on line 39 (nominally about 198 Vdc for a 110 Vrms input). The energy recovery pump 34 receives, in addition to the rectified voltage, Vin, on line 8 from the input power unit 30, an additional voltage, Vadd, on line 6 from the resonant network 33 of fluorescent lamp assembly 3 (or alternatively and/or additionally from the feedback unit 102 or the feedforward unit 103). The additional voltage, Vadd, on line 6 significantly improves the power efficiency and the power factor of the fluorescent lamp 1, by reducing the Irms input line current.

In FIG. 1, the half-bridge power stage 38 switches the Vcomb voltage on line 39 to form an AC high-frequency (for example, 50 kHz) drive voltage, Vdrive, (nominally about 156 Vp-p for a Vin of about 110 Vrms) on line 5, see FIG. 12, to drive the fluorescent lamp assembly 3. The half-bridge power stage 38 is controlled by the half-bridge driver 36. The half-bridge driver 36 receives the Vcomb input from energy recovery pump 34 on line 39 and receives the Vdrive input from line 5 to provide control inputs to half-bridge power stage 38 on lines 36-1 and 36-2.

In FIG. 1, the fluorescent lamp assembly 3 receives the high-frequency drive voltage Vdrive on line 5 from the half-bridge power stage 38. The high-frequency drive voltage drives the resonant network 33 of the florescent lamp assembly 3 causing a resonant oscillation and an oscillating current that generates the fluorescent light. Also, the output of the resonant network 33 of the fluorescent lamp assembly 3 connects the Vadd voltage (nominally about 56 Vp-p for a Vin of about 110 Vrms) on line 6 to the energy recovery pump 34 to supply the additional voltage to pump 34 that enhances the power efficiency and power factor, by reducing the Irms input line current, of the fluorescent light 1.

In an alternate embodiment, in addition to connecting to the fluorescent lamp assembly 3, the high-frequency drive 5 connects to the feedback unit 102 to provide an additional voltage on line 6 feeding the energy recovery pump 34. In another alternate embodiment, the feedforward unit 103 receives power from the input power unit 30 to provide an additional voltage on line 6 feeding the energy recovery pump 34. If line 6 from the florescent lamp assembly 3 does not connect to the energy recovery pump 34 in the alternate embodiments, the florescent lamp assembly 3 may otherwise terminate, for example in termination unit 131, which in a typical example is a 100 nF blocking capacitor C_{B}.

An analysis of the Power Factor (PF) as applied to a florescent lamp with the energy recovery pump 34 of FIG. 1 is as follows.

Power Factor={True Power(P)}/{Apparent Power(S)} (Eq.1)

PF=P/S (Eq.2)

True Power (P) is the actual power dissipated by the load current, Idc, in a dissipative resistive load, R, is as follows:

P={I²dc}·{R} (Eq.3)

The Apparent Power (S) is the power dissipated by the line current, Irms, in a reactive load with a reactive impedance, Z, is as follows:

S={I²rms}·Z (Eq.4)

Expressing PF as a function of line current, Irms, and load current, Idc, yields:

PF=[{I²dc}*R]/{I²rms·Z} (Eq.5)

For a purely resistive load, R, Eq. (5) becomes Eq. (3) since Z=R and Irms=Idc and therefore, in Eq. (5) for a purely resistive load, PF=1.

For the energy recovery pump 34, the phase displacement between the line current and the input line voltage is a constant. However, the input line current varies greatly with the peak-to-peak level of the additional voltage Vadd in the energy recovery pump 34. In feedback embodiments described, the input line current ranges from 1.6A to 0.90A for Vadd ranging from 10 Vp-p to 120 Vp-p.

In Eq. (5), due to the operation of the energy recovery pump 34, the Power Factor (PF) is measured as a function of a Reduction Coefficient, Kred, as follows:

PF=[{I²dc}·{R}]/[{Kred}·{I²rms}·{Z}] (Eq.6)

In the examples described, the reduction coefficient, Kred, varies from 1 to less than 0.56. In particular, Kred=1 when Vadd=10 Vp-p, and Kred=0.56 when Vadd=120 Vpp. It is clear from Eq. (6) that as the product {Kred}·{Irms} decreases, the overall Power Factor increases.

In FIG. 2, the energy recovery pump 34 of FIG. 1 is shown. The energy recovery pump 34 includes a first pump element 12 (Dp1), a second pump element 15 (Dp2) and a pump control 124 including pump control element 124-1 and pump control element 124-2. An energy source supplies an input voltage Vin on the input line 8 from the input unit 30 of FIG. 1. The input voltage on line 8 is connected to the first pump element 12 (Dp1). The first pump element 12 connects to a second pump element 15 (Dp2) at pump node 125. The first pump element 12 (Dp1) operates for unidirectional conduction of an input current in response to the input voltage. When the pump element 12 is conducting (ON), energy is supplied through the first pump element 12 to the node 125 between the series-connected first pump element 12 and the second pump element 15 and from node 125 through the second pump element 15 to charge the C3 bulk capacitor 18. A source such as resonant network 33 of FIG. 1 provides an additional voltage, Vadd, supplied as the input on line 6, from the high-frequency (for example, 50 kHz) resonant network 33 (in the florescent lamp assembly 3, see FIG. 1). Alternate additional energy inputs are provided from other sources such as from the feedback unit 102 or from the feedforward unit 103 in FIG. 1 to the pump control 124. The alternate voltage, Vadd, from line 6 input to pump control 124 is combined with the input voltage, Vin, to control when the rectified input voltage, Vin, conducts through first pump element 12 is used to charge the C3 bulk capacitor 18. When the first pump element 12 is non-conducting (OFF), then only the energy supply from the alternate voltage, Vadd, on line 6 operates to cause current through the second pump element 15 to charge the C3 bulk capacitor 18. The second pump element (Dp2) is connected at pump node 125 to the first pump element 12 (Dp1) for unidirectional conduction of a charging current to charge the C3 bulk capacitor 18.

In the energy recovery pump 34, the node 125 is used as a combining node for combining the rectified input voltage, Vin, on line 8 and the additional voltage, Vadd, on line 6 to form a combined voltage, Vcomb. The combined voltage, Vcomb, establishes a voltage threshold. When the input voltage, Vin, is greater than the voltage threshold, Vin causes conduction for charging the C3 bulk capacitor 18. When the input voltage, Vin, is less than the voltage threshold, Vin is OFF and Vadd causes conduction for charging the C3 bulk capacitor 18. The first pump element 12 and the second pump element 15 are both unidirectional elements so that currents from the rectified input voltage, Vin, and the additional voltage, Vadd, sources only charge the C3 bulk capacitor 18. The C3 bulk capacitor 18 is discharged by delivering energy to the florescent lamp assembly 3 after being converted to a high-frequency drive voltage, Vdrive, by half-bridge power stage 38.

In FIG. 2, the energy recovery pump 34 substantially improves the power efficiency of the fluorescent lamp 1. The power efficiency results from the high-efficiency power transfer of energy to the bulk capacitor 18 by operation of the power control elements 124-1 and 124-2. The high-efficiency power transfer occurs without significantly affecting the resonant frequency of the resonant network 33 of the fluorescent lamp assembly 3 of FIG. 1. In order to balance the high-efficiency power transfer of energy to bulk capacitor 18, the power control element 124-2 preferably has a capacitive value approximately ten times greater than the capacitive value of the power control element 124-2. Concurrently, the capacitance value of the power control element 124-2 must not be too small relative to the capacitive value of the resonant capacitor 20. While the capacitive value of the power control element 124-2 preferably has a capacitive value of ten or more times greater than the value of the resonant capacitor 20, it has been determined that for balanced operation, the power control element 124-2 may have a capacitive value approximately five times greater than resonant capacitor 20 in order to maximize energy transfer without unduly affecting the resonant frequency of resonant network 33. While the capacitive value of the power control element 124-1 theoretically may be any high value as long as the power control element 124-1 has a capacitive value equal to or more than approximately ten times greater than the capacitive value of the power control element 124-2, the higher the capacitive value of the power control element 124-1, the greater the size of the power control element 124-1. In order to fit the power control element 124-1 within a small base cup volume, for example, less than about 2.5 in³, the power control element 124-1 cannot be any arbitrary high value since excessively high values result in excessive size or cost. The objective is to have a balanced energy recovery pump 34 where the resonance of the network 33 is not disturbed and energy is recovered and transferred to bulk capacitor 18 in an amount that substantially increases the luminous efficiency (lumens/watt) of the fluorescent lamp 1.

In FIG. 2, power is delivered on line 8 from the at the input power unit 30 of FIG. 1 which receives on lines 9 power from the power source 101. Since the C3 bulk capacitor 18 is a reactive load, the input current tends to lead the input voltage causing an undesirably low power factor. In the present embodiments, however the energy recovery pump 34, in addition to improving the luminous efficiency, prevents a low power factor by substantially reducing the Irms input line current which would otherwise result in the absence of the energy recovery pump 34.

When the present invention is used for compact florescent lamps, it has been found that less than approximately 11 watts are required for 1100 lumens and less than approximately 16 watts are required for 1600 lumens. Accordingly, fluorescent lamps of embodiments of the present invention using balanced energy recovery pumps have an 84% improvement in power reduction relative to incandescent lamps and have an improvement in power reduction equal to approximately 30% relative to conventional compact fluorescent lamps. Such power improvement is achieved with better than a 0.8 (80%) power factor.

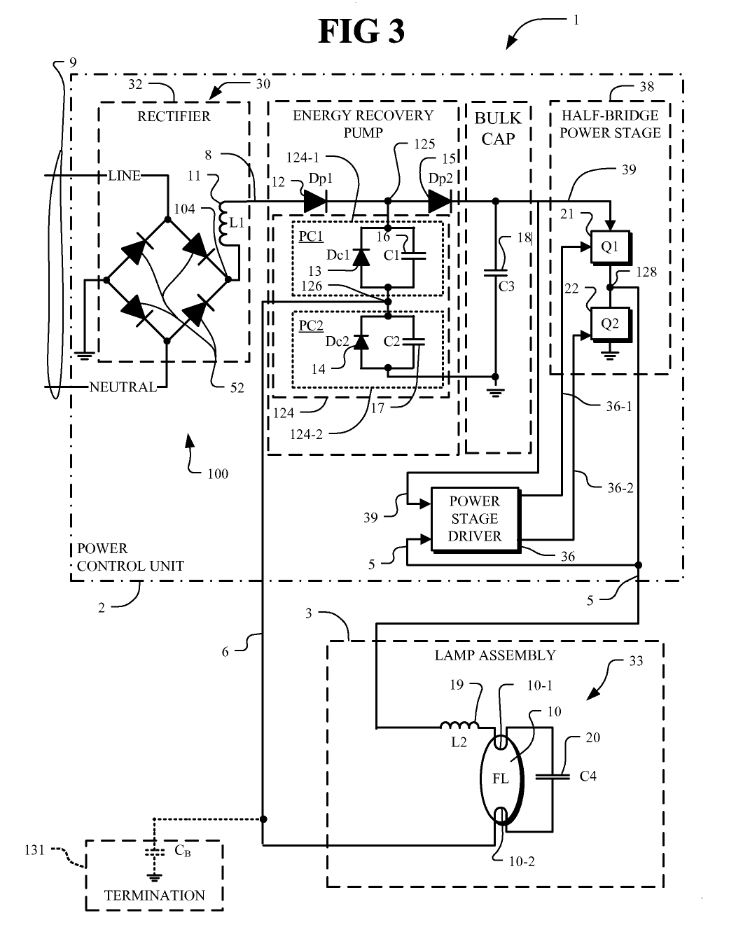

In FIG. 3, a detailed block and circuit diagram of one embodiment of the power control unit 2 and lamp assembly 3 of FIG. 1 is shown. The power control unit 2 includes the input power unit 30 which in the present embodiment includes a full-wave rectifier 32 and the L1 inductor 11 (typically 763 μh). The L1 inductor 11 is useful for minimizing high frequency, resonant harmonic components that may be present in input power lines and for helping to reduce or eliminate light flicker when light dimming is preformed using a conventional triac dimmer.

The diodes 52 are connected in a conventional manner between the input AC power service having LINE and NEUTRAL inputs at a pair of opposite nodes and with ground and an output at node 104 to L1 inductor 11 connected at the other pair of opposite nodes to form through L1 inductor 11 the rectified input voltage, Vin, on line 8. With a 110 volt, 60 Hz sinusoidal line voltage across the LINE and NEUTRAL inputs, the rectifier 32 operates to provide a full-wave rectified DC voltage on line 8 (nominally 156 Vp-p for a 110 Vrms input).

In FIG. 3, the energy recovery pump 34 includes the first pump diode 12 (Dp1) as the first pump element, the second pump diode 15 (Dp2) as the second pump element. A pump control 124 in the embodiment of FIG. 3 includes diode-capacitor network formed by the first control diode 13 (Dc1), the second control diode 14 (Dc2), the first capacitor 16 (C1) and the second capacitor 17 (C2). The first control diode 13 and the second control diode 14 connected at a control node 126 and connect in series between a reference level (ground) and the pump node 125. The first control capacitor 16 (C1) and the second control capacitor 17 (C2) connect at the control node 126 and connect in series between the reference level (ground) and the pump node 125. The additional voltage on line 6 is connected at the control node 126, the second capacitor 17 and the C1 capacitor 16. In one embodiment, the values of the components in the energy recovery pump 34 for a typical CFL 110 Vrms florescent lamp embodiment are given in the following TABLE 1.

TABLE 1

| | |
|---|---|
| Dp1 | HER107 |
| Dp2 | HER107 |
| Dc1 | HER107 |
| Dc2 | HER107 |
| C1 | 220 nF |
| C2 | 22 nF |
| C3 | 15 μF |

In another embodiment, the values of the components in the energy recovery pump 34 for a typical long tube 220 Vrms florescent lamp embodiment are given in the following TABLE 2.

TABLE 2

| | |
|---|---|
| Dp1 | CMR1F-06M |
| Dp2 | CMR1F-06M |
| Dc1 | CMR1F-06M |
| Dc2 | CMR1F-06M |
| C1 | 220 nF |
| C2 | 22 nF |
| C3 | 47 μF + 47 μF (series) |

In TABLE 2, C3 is implemented in one embodiment with two series connected capacitors that as connected are able to withstand a 500 Vdc breakdown voltage as is required when operating with a 220 Vrms input voltage. The CMR1F-06M diodes are surface mount components that facilitate a compact implementation. The CMR1F-06M diodes or other surface mount components similarly may be used in the TABLE 1 embodiment.

In FIG. 3, the lamp driver 100 of FIG. 1 is the half-bridge power stage 38 and the half-bridge driver 36. The half-bridge power stage 38 includes a Q1 first drive transistor 21 and a Q2 second drive transistor 22. The first drive transistor 21 and the second drive transistor 22 are connected at a drive node 128 and are connected in series between the C3 bulk capacitor 18 and a reference level (ground). The Q1 transistor 21 and the Q2 transistor 22 are alternately switched, under control of half-bridge driver 36 through gate signals on lines 36-1 and 36-2, respectively, so that Q1 transistor 21 is conducting when Q2 transistor 22 is not and vice versa. The half-bridge driver 36 determines the frequency of switching of the Q1 transistor 21 and the Q2 transistor 22 and hence the frequency of the drive voltage (for example, 50 kHz) on line 5 that drives the fluorescent lamp assembly 3. The half-bridge driver 36 and the half-bridge power stage 38 can be implemented using integrated circuit components, non-integrated circuit components and combinations thereof. The drive node 128 connects on line 5 to the lamp assembly 3.

In FIG. 3, the lamp assembly 3 includes the resonant network 33 formed by the resonant L2 inductor 19 and the resonant C4 capacitor 20 connected in series with the filaments 10-1 and 10-2 of the florescent tube 10. In one embodiment, the nominal values of the components and filaments in the lamp assembly 3 are given in the following TABLE 3:

TABLE 3

| | | |
|---|---|---|
| L2 | 2 | mh |
| C4 | 4.1 | nF |

| | |
|---|---|
| 10-1 | 5.1Ω |
| 10-2 | 5.1Ω |

The operation of the fluorescent lamp 1 of FIG. 3 is as follows. The half-bridge power stage 38 provides a high-voltage, high-frequency drive voltage on line 5 connected to the lamp assembly 3. Typically, the drive voltage on line 5 is nominally a 198 Vp-p square wave with a 50% duty cycle. The RLC resonant network 33 composed of L2 inductor 19, C4 capacitor 20 and filaments 10-1 and 10-2 receives energy from the C3 bulk capacitor 18 of the energy recovery pump 34. The energy is connected in the form of an AC square wave drive voltage on line 5 resulting from the switching ON and OFF of the Q1 and Q2 transistors 21 and 22 in the half-bridge power stage 38. The resonant network 33 oscillates at the 50 kHz frequency of the square wave drive voltage on line 5. As a result of the operation of the resonant network 33 being driven by the high-frequency drive voltage, a nominally sinusoidal voltage waveform occurs as the additional voltage, Vadd, on the return line 6. The additional voltage on the return line 6 has the same high frequency as the drive voltage on line 5. The return line 6 connects to control node 126 in the energy recovery pump 34. The C2 capacitor 17 functions as a DC blocking capacitor.

Rather than as shown connecting to the energy recovery pump 34, if the return line 6 connects through a C_{B} blocking capacitor (with a nominal value of 100 nF) to ground, the voltage at line 6 would be nominally a sine wave, on a high voltage DC rail of half the voltage at the bulk capacitor, with a high-frequency sine wave of about 20 Vp-p centered at half the voltage at the bulk capacitor as a result of the operation of such a C_{B} blocking capacitor and a divider resistor network (not shown) connected between the bulk capacitor and ground. The C_{B} blocking capacitor would be connected at the junction of the two series biasing resistors.

However, with the return line 6 connected to the energy recovery pump 34 at node 126 with the C2 capacitor 17 being the DC blocking capacitor as shown in FIG. 3, the nominal 28 Vp-p on the return line 6 is clamped at about +70 V by the action of the Dc2 second control diode 14. The sine wave on the return line 6 is biased nominally at about +70 V and rises to a nominal peak voltage of about 14 Vp producing nominally 28 Vp-p. The purpose of the Dc2 diode 14 is to level shift the 28 Vp-p sine wave to the +70 V level above ground potential, using a DC restoring method. The DC level above ground is a function of the peak-to-peak amplitude of the waveform at line 6. Therefore, the action of the Dc2 second control diode 14 is to “DC pump” the Vrms level at line, 6.

The voltage at the pump node 125 between the Dp1 diode 12 and the Dp2 diode 15 is a summation of a 60 Hz derived full-wave rectified wave input voltage, Vin, from line 8, connected through the Dp1 diode 12, with a 50 kHz, 28 Vp-p nominal sine wave additional voltage, Vadd, from line 6, connected through the Dc1 first control diode 13 and the C1 first capacitor 16 (see FIG. 14). Depending on the amount of current being drawn on line 39 by the load of the half-bridge driver 38, the energy recovery pump 34 suppresses ripple that would otherwise exist on line 39, as well as to increase the peak rectified voltage at line 8, by the superposition of two waveforms at the pump node 128. The C3 bulk capacitor 18 is being charged to higher level than the voltage at line 8.

The operation of recharging the C3 bulk capacitor 18 is shared between (i) the low-frequency (60 Hz) derived input voltage from the full-wave rectifier 32, Vin, over input line 8 and (ii) the high-frequency (50 kHz) additional voltage, Vadd, from the resonant network 33 of the lamp assembly 3 on line 6. Because the frequency of the additional voltage embodiment described is much higher than the frequency of the input voltage, the phase of the additional voltage relative to the phase of the input voltage need not be considered since the additional voltage is active many times over each single cycle of the input voltage.

The peak-to-peak, 60 Hz ripple on the input line 8 from rectifier 32 affects the amount of recharge current for the C3 bulk capacitor 18 being supplied from the AC lines 9 versus the amount of recharge current for the C3 bulk capacitor 18 from the resonant circuit 33. The recharge current to the C3 bulk capacitor 18 is provided by the resonant network 33 of the lamp assembly 3 over input line 6 during the time that the voltage output from the full-wave rectifier 32 is below the DC voltage at line 39. This operation of using energy from the resonant network of the lamp assembly 3 is an energy-adding operation of the energy recovery pump 34.

During the portion of any 60 Hz period when the voltage at line 8 is lower than the voltage at node 125, the energy recovery operation provides the current required to recharge the bulk C3 capacitor 18, as a result of the high-frequency sine wave voltage from line 6, using Dc1 diode 13 and C1 capacitor 16. During this energy recovery charging period, the Dp1 diode 12 is back biased and does not permit recharging current from the input on line 8 from the rectifier 32. Only when the voltage at line 8 is sufficiently high to make the Dp1 diode 12 conduct is any current drawn from line 8 and ultimately from the input AC line 9. Accordingly, the current drawn from the input AC line 9 is minimized by the action of the energy recovery from the resonant network 33 of the lamp assembly 3 and consequently, the power factor (PF) is greater than about 0.8 (80%) and in some embodiments more than 0.9 (90%).

In FIG. 3, for good performance of the energy recovery pump 34, one embodiment uses the C2 capacitor 17 for DC-blocking with a value of 22 nF while the resonant C4 capacitor 20 in lamp assembly 3 has a value of 4.0 nF. Accordingly, there is 5.5 times difference between the C2 capacitor 17 and the C4 capacitor 20 capacitances.

The stored energy in the resonant tank of the resonant network 33 of the lamp assembly 3 is transferred to the C3 bulk capacitor 18 through the Dp2 diode 15. In order for the energy recovery pump to work optimally, the relative values of C 1 capacitor 16 and C2 capacitor 17 are selected as at least about 10 times in difference. In the particular embodiment described, the C2 capacitor 17 is 22 nF while the C1 capacitor 16 is 220 nF for a 10 times difference. A larger than 10 times difference undesirably increases the size of the C1 capacitor 16 (typically a film/Mylar capacitor necessary to handle the high voltage breakdown requirement at the pump node 125, at the switching frequency). A 10 times multiplier between C1 capacitor 16 and C2 capacitor 17 capacitances is used so that a substantial amount of the voltage at the control node 126 will be transferred to the C3 bulk capacitor 18 via the Dc1 first control diode 13.

The times that the Dc1 first control diode 13 is active is during the times when the Dp1 first pump diode 12 is back biased. The Dc1 first control diode 13 is a key element in producing the needed voltage at its cathode during the time that the Dp1 first pump diode 12 is back biased. The voltage on line 6 is allowed to charge the C3 capacitor 18, via the current in Dp2 diode 15 when the Dp1 diode 12 is back biased, and the Dc1 diode 13 is forward biased which occurs during low points of the fully rectified voltage at line 8. During the time that the Dp1 diode 12 is ON, the voltage at line 6 is operating normally, with the C2 capacitor 17 and C1 capacitor 18 combined in parallel, actually increasing the value of the DC blocking capacitance from the C2 capacitor 17 value to the parallel combination of the C2 capacitor value and the C3 capacitor 18 value. During the time that Dp1 diode 12 is forward biased, the voltage at the pump node 125 is a low impedance point which is equivalent to a grounded point with reference to AC. Therefore, the resonant behavior of the resonant L2 inductor 19 and resonant C4 capacitor 20 in lamp assembly 3 continues to operate in a resonant manner.

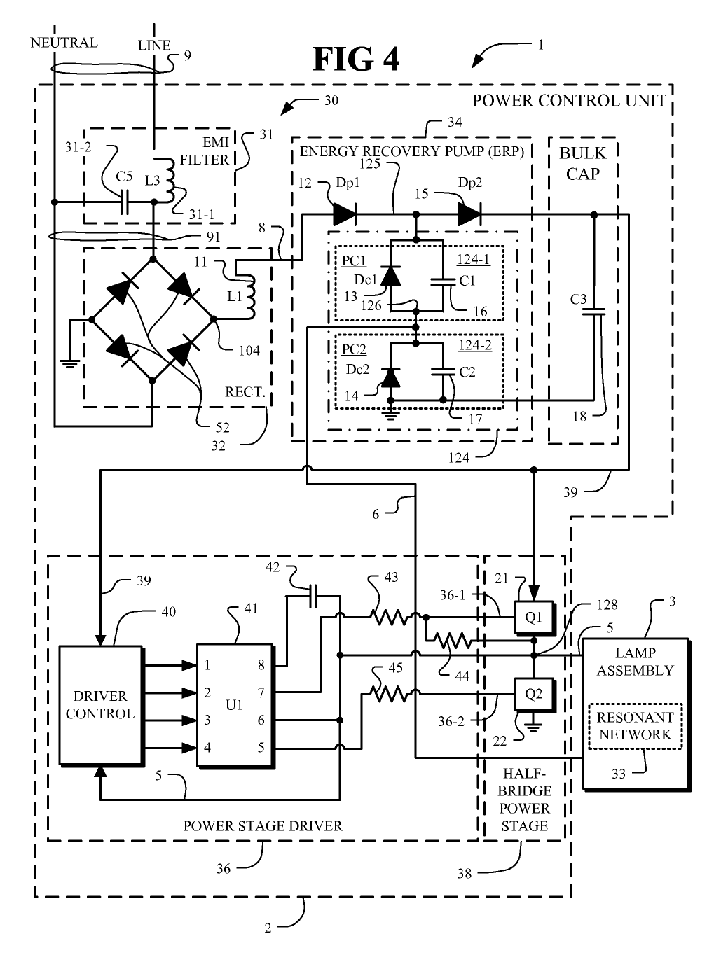

In FIG. 4, a detailed block and circuit diagram of one embodiment of the power control unit 2 and lamp assembly 3 of FIG. 1 is shown. The power control unit 2 includes the input power unit 30 which in the present embodiment includes an (electromagnetic interference) EMI filter 31 and a full-wave rectifier 32. The EMI filter 31 includes the L3 inductor 31-1 and the C5 capacitor 31-2, typically 1.1 mH and 47 nF. The EMI filter 31 is optional and is useful to suppress the sharp voltage transitions that may be present on the input power line 9. The L3-C5 node of the EMI filter 31 together with the NEUTRAL line form the AC input 9-1 to the rectifier 32 which operates to provide a filtered full-wave waveform at node 104 through the L1 inductor 11 of nominally 156 Vp-p from 110 Vrms mains.

In FIG. 4, the energy recovery pump 34 includes the Dp1 first pump diode 12, includes the Dp2 second pump diode 15, includes the pump control 124 and includes the C3 bulk capacitor 18. In the FIG. 4 embodiment, the values of the components in and the operation of the energy recovery pump 34 are typically the same as described in connection with FIG. 3.

In FIG. 4, the half-bridge power stage 38 includes Q1 drive transistor 21 and Q2 drive transistor 22 which in the FIG. 4 embodiment are typically STDc2NC45-1 MOSFETS. In operation, the Q1 transistor 21 and the Q2 transistor 22 are alternately switched, under control of half-bridge driver 36 through gate signals on lines 36-1 and 36-2, respectively, and the resistors 43 and 45, respectively, so that Q1 transistor 21 is conducting when Q2 transistor 22 is not and vice versa. The half-bridge driver 36 determines the frequency of switching of the Q1 transistor 21 and the Q2 transistor 22 and hence the frequency of the drive voltage (for example, 50 kHz) on line 5 that drives the resonant network 33 of the fluorescent lamp assembly 3.

In FIG. 4, the power stage driver 36 employs the STMicro L6569 integrated circuit (or any equivalent integrated circuit such as the IRS2153(1)DSPbF) as the U1 integrated circuit 41. The U1 integrated circuit 41 directly controls the half-bridge power stage 38. The U1 circuit 41 has external connection pins 1, 2, . . . , 8. Connection pins 5 and 7 drive the half-bridge MOSFET Q3 and Q4 gates 87-1 and 87-2 through resistors 43 and 45, respectively, and the capacitor 42 is 100 nF. Resistor 44 connects the gate line 36-1 to pin 6 of the U1 integrated circuit chip 41 and input 5 to the lamp assembly 3. The resistors 43, 44 and 45 in the embodiment described have values of 20Ω, 10 KΩ and 20Ω, respectively. The MOSFET Q3 and Q4 gates 87-1 and 87-2 are driven in a complementary fashion with a 1.25 μs built-in dead time to prevent cross conduction. The U1 circuit 41 includes an oscillator that operates from 25 to 150 kHz with a +/−5% maximum tolerance and in the present embodiment is set to 50 kHz. The U1 circuit 41 includes a 9V Under Voltage Lock Out (UVLO) with a 1 V hysteresis that requires only 150 μA at power up. The U1 circuit 41 provides a high voltage output on pin 8 to charge the bootstrap capacitor 42.

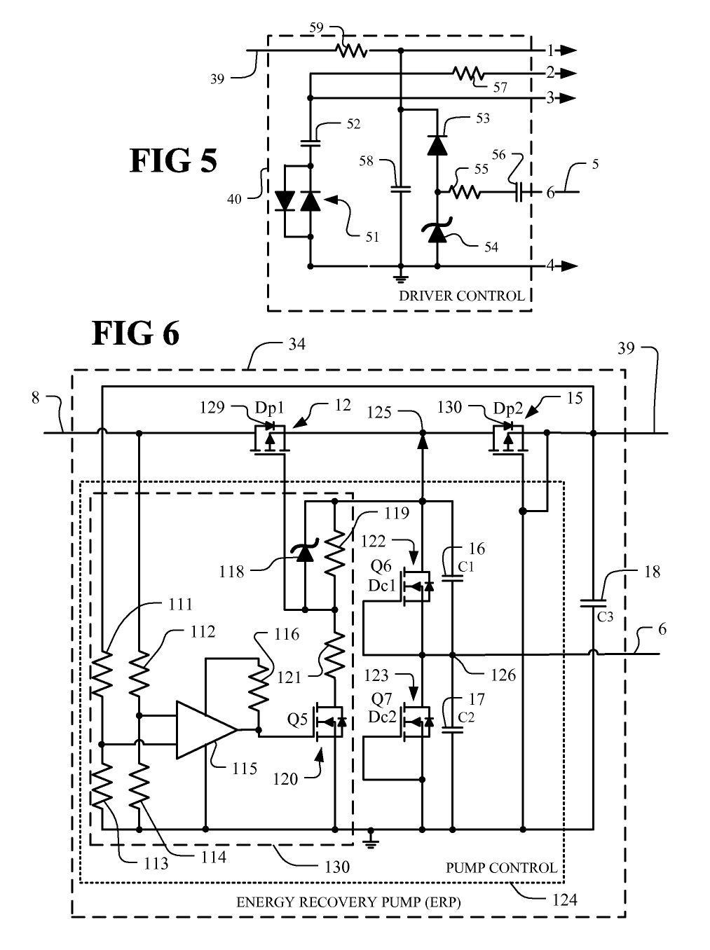

In FIG. 5, the driver control 40 of FIG. 4 is shown in detail. The driver control 40 provides the inputs to the U1 integrated circuit 41 pins 1, 2, 3 and 4 and receives the pin 6 output. The line 7 input from the energy recovery pump 34 connects directly as the voltage input pin 1.

In FIG. 5, the anti-parallel diodes 51 connect from ground through capacitor 52 to the input pin 3 and through resistor 57 to the input pin 2. The input pin 4 is connected to ground. The capacitor 58 is connected from ground to the pin 1 input. The diodes 54 and 53 connect from ground to the pin 1 input. The pin 6 output connects through capacitor 56 and resistor 55 to the node between diodes 53 and 54. The timing components 59 and 57 determine the switching frequency, F_{S}, of the resonant frequency and is determined by the following equation where Rt is the value of resistor 57 and Ct is the value of capacitor 52:

Fₛ˜1/[(1.453)·(Rt)·(Ct)] (Eq.7)

In the embodiment described, the components of FIG. 5 have the values as set forth in the following TABLE 4:

TABLE 4

| 51 | BY100-100 | |
|---|---|---|
| 52 | 560 | pF |
| 53 | IN4148 | |
| 54 | IN5248 | |
| 55 | 51Ω | |
| 56 | 470 | nF |
| 57 | 16.2 | kΩ |
| 58 | 47 | μF |

In the FIG. 4 embodiment, the lamp assembly 3 includes the resonant network 33 which is the same as the resonant network 33 in FIG. 3.

In operation of the FIG. 4 embodiment with the FIG. 5 driver control, the U1 circuit 41 provides three functions for the lamp assembly 3, namely, pre-heat, ignition, and normal lamp operation. The values of the inductive and capacitive components in the resonant circuit 33 determine the lamp ignition voltage and the nominal lamp current and in FIG. 4 have the same values as described in connection with FIG. 3.

In FIG. 4, the performance of the energy recovery pump 34 is essentially the same as in FIG. 3. The stored energy in the resonant tank of the resonant network 33 of the lamp assembly 3 is transferred to the C3 bulk capacitor 18 through the Dp2 diode 15. The relative values of C1 capacitor 16 and C2 capacitor 17 are 10 times in difference and essentially substantially all the voltage at the control node 126 is transferred to the C3 bulk capacitor 18 via the Dc1 first control diode 13.

In FIG. 4 as in FIG. 3, the time that the Dc1 diode 13 is active is during the time that the Dp1 diode 12 is back biased. The Dc1 diode 13 is a key element in producing the needed voltage at its cathode during the time that the Dp1 diode 12 is back biased. The voltage on line 6 is only allowed to charge the C3 capacitor 18, via, the Dp2 diode 15 when the Dp1 diode 12 is back biased, and the Dc1 diode 13 is forward biased which occurs during low points of the fully rectified voltage at line 8. During the time that the Dp1 diode 12 is on, the voltage at line 6 is operating normally with the C2 capacitor 17 and C1 capacitor 18 in parallel, actually increasing the value of the DC blocking capacitance from the C2 capacitor 17 value to the parallel combination of the C2 capacitor value and the C3 capacitor 18 value. During the time that Dp1 diode 12 is forward biased, the voltage at the pump node 125 is a low impedance point which is equivalent to a grounded point, AC wise. Therefore, the resonant behavior of the resonant L2 inductor 19 and the resonant C4 capacitor 20 in lamp assembly 3 continues.

In FIG. 6, a MOSFET embodiment of the energy recovery pump 34 of FIG. 2 is shown. In FIG. 6, the energy recovery pump 34 includes a first pump element 12 (Dp1), a second pump element 15 (Dp2) and a pump control 124. A first energy source is the input voltage, Vin, on line 8 from the input unit 30 (which includes a full wave rectifier 32, see FIG. 3, and originally derived from the 60 Hz power source 101 of FIG. 1). The first energy source is connected to conduct through the first pump element 12 (Dp1). When the first pump element 12 is conducting (ON), energy is supplied through the pump element 12 to the pump node 125 connected between the pump element 12 and the pump element 15 and from there through the pump element 15 to charge the C3 bulk capacitor 18.

An additional energy source supplies to the pump control 124 an additional voltage, Vadd, on line 6, in one embodiment from the high-frequency (for example, 50 kHz) resonant network 33 (in the florescent lamp assembly 3, see FIG. 1). The additional voltage in other embodiments is derived from other sources (such as feedback unit 102 or feedforward unit 103 in FIG. 1). The pump control 124 functions to control the energy sources used to recharge the C3 bulk capacitor 18. When the operation of pump control 124 renders the pump element 12 non-conducting (OFF), then the energy supply is from the additional energy source over the input on line 6. In one particular embodiment, the node 125 is used as a summing node for summing the input voltage on line 8 and the additional voltage on line 6 whenever the first pump element 12 is conducting (ON). The pump element 12 and the pump element 15 are both unidirectional so that current from the first and additional energy sources can only charge the C3 bulk capacitor 18. The C3 bulk capacitor 18 is discharged by delivering energy to the florescent lamp assembly 3.

In FIG. 6, the pump control 124 includes a comparator unit 130 for comparing the voltage on the C3 bulk capacitor 18 as it appears on output line 39 to the input voltage on input line 8. The voltage on input line 8 feeds through the series connected level-setting resistors 112 and 114 to ground with the connection node between resistors 112 and 114 connected to one input of comparator 115. The voltage on output line 39 feeds through level setting resistors 111 and 113 to ground with the connection node between resistors 111 and 113 connected to the other input of comparator 115. The comparator 115 is connected to ground and with the resistor 116 to its output connected in turn to the gate of the Q5 transistor 120. The source-to-drain of the Q5 transistor 120 connects through resistors 121 and 119 to the pump node 125. The diode 118 is connected across the resistor 119. The connection node between resistors 119 and 121 connects to the gate of the Dp1 first pump element 12. The C1 first control capacitor 16 connects across the source-to-drain of the Q6 transistor 122 and the C2 second control capacitor 17 connects across the source-to-drain of the Q7 transistor 123. The internal parasitic diode 129 connects from the drain to the source of the Dp1, first control transistor 12, and the second internal diode 130 from the drain to the source of Dp2, second control transistor 15 which is also connected at the output line 39.

The energy recovery pump 34 includes a first pump element 12 (Dp1), a second pump element 15 (Dp2) and a pump control 124. The input voltage, Vin, on line 8 from the unit 30 of FIG. 1 (including a full wave rectifier 32, see FIG. 3) connects to the Dp1 first pump element 12. The additional voltage, Vadd, on line 6 connects from the fluorescent lamp assembly 3 of FIG. 1 to the pump control 124 and specifically to the control node 126 between C1 first control capacitor 16 and C2 second control capacitor 17. The pump control 124 operates to conduct a recharging current through the Dp1 pump element 15 to recharge the voltage on the C3 bulk capacitor 18 as a function of the comparative values of the input voltage, Vin, on line 8 and the additional voltage, Vadd, on line 6. The output from the Dc1 pump element feeds the half-bridge power stage 38 of FIG. 1.

All of the transistors Dp1, Dp2, Dc1, Dc2 and Q5 numbered 12, 15, 122, 123 and 120, respectively, are MOSFETs. The energy recovery pump 34 functions to control instantaneously the recharging of the C3 bulk capacitor 18.

For the comparator 115, the threshold level at which the Dp1 first pump element 12 is turned OFF has a sensitivity of less than 100 millivolts measured as a difference between a voltage threshold which in the present embodiment is the output voltage, Vcomb, on line 39 nominally of about +198V and the full-wave rectified input voltage, Vin, on line 8 as level adjusted by the resistors 111, 112, 113 and 114. This sensitivity means that the resonant waveform additional voltage on line 6 at the control node 126 can be engaged much sooner (by a factor of at least 10 times faster) in the MOSFET embodiment of pump control 124 in FIG. 6 as compared with the corresponding diode pump control 124 in FIG. 4. In addition, because the ON resistance drain-to-source (Rds) of both P-Channel MOSFETs, that is the Dp1 first pump transistor 12 and Dp2 second pump transistor 15, is low, the voltage drop across both Dp1 and Dp2 is significantly lower than the 0.7V to 0.8V of the diode energy recovery pump 34 of FIG. 3. Accordingly, the power dissipation of the energy recovery pump 34 of FIG. 6 is substantially less than the power dissipation of energy recovery pump 34 of FIG. 3.

The operation of FIG. 6 is as follows. For a rectified input voltage, Vin, on line 8 at or greater than nominally +156 Vp-p, and higher in amplitude than on line 39, the state of comparator 115 is high turning Q5 transistor 1200N. When Vin drops by just a few millivolts relative to level on line 39, the state of the comparator 115 is low, turning Q5 transistor 120 OFF. When Q5 transistor 120 is ON, diode 118, a 10 V zener diode, limits the gate-to-source voltage of Dp1 first pump transistor 12 to a maximum of −10 V. The Q5 transistor 120 is an N-Channel FET requiring a positive differential voltage between the gate and source to turn ON. The maximum breakdown of the gate-to-source voltage on Dp1 transistor 12 is −20 V. When Q5 transistor 120 is OFF, the voltage between the gate and source of Dp1 is zero volts, causing Dp1 transistor 12 to turn OFF and allowing the resonant waveform of the additional voltage, Vadd, on line 6 to begin charging C3 bulk capacitor 18, much sooner than with the previous diode design of the energy recovery pump 34 in FIG. 3. The Dp2 second pump element 15, on the other hand, is biased always OFF by the connection between the gate and source of P-channel Dp2 second pump transistor 15. The intrinsic parasitic diodes of the Dc1 first control transistor 122 and the Dc2 second control transistor 123 provide convenient diodes.

The MOSFET topology of FIG. 6 is integrated into a MOSFET integrated circuit chip to form a fully integrated energy recovery pump 34. Typical values for FIG. 6 components are given in the following TABLE 5:

TABLE 5

| 11 | 763 | μH |
|---|---|---|
| 12 | pMOSFET | |
| 15 | pMOSFET | |
| 16 | 220 | nF |
| 17 | 22 | nF |
| 18 | 15 | μF |
| 111 | 51 | kΩ |
| 112 | 51 | kΩ |
| 113 | 909Ω | |
| 114 | 1 | kΩ |
| 116 | 51 | kΩ |
| 118 | IN5240B | |
| 119 | 51 | kΩ |
| 120 | nMOSFET | |
| 121 | 51 | kΩ |

| | |
|---|---|
| 122 | nMOSFET |
| 123 | nMOSFET |

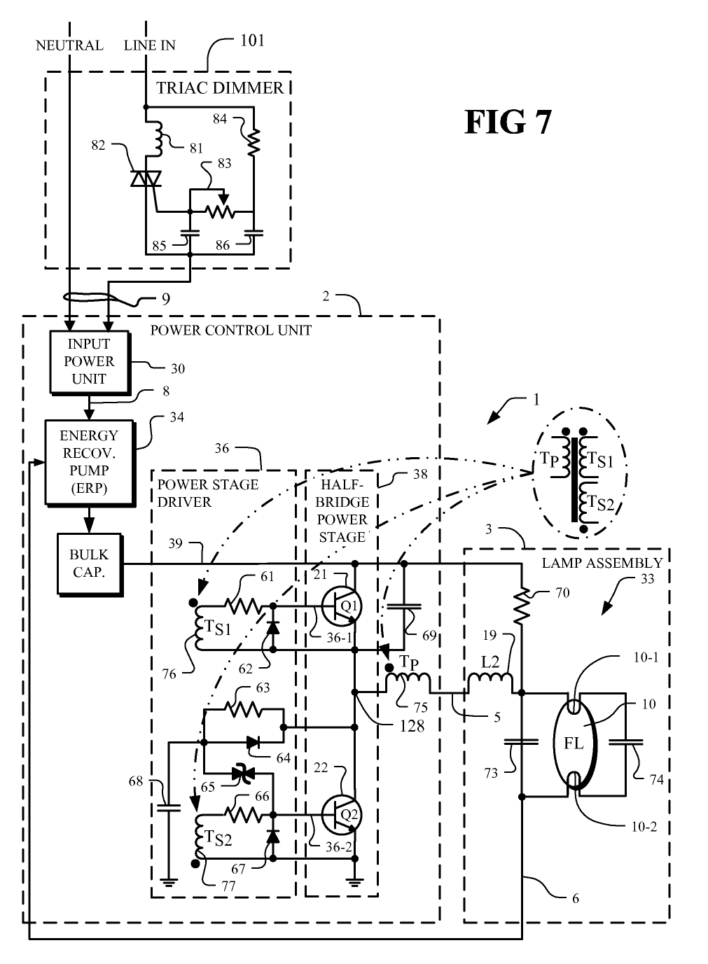

In FIG. 7, the power source 101 includes a triac dimmer of conventional design receiving the NEUTRAL and LINE IN power lines providing input lines 9 to input power unit 30.

In FIG. 7, a block and circuit diagram of another embodiment of the power control unit 2 and lamp assembly 3 of FIG. 1 is shown connected to the power source 101. The power source 101 includes a triac dimmer of conventional design receiving the NEUTRAL and LINE IN power lines providing input lines 9 to input power unit 30. The input power unit 30 operates to provide a filtered full-wave rectified DC voltage on line 8 of nominally 156 Vp-p when the triac dimmer 101 is not phase-chopping the input on lines 9.

In FIG. 7, the half-bridge power stage 38 includes Q1 drive transistor 21 and Q2 drive transistor 22 which in the present embodiment are typically MJE13003 bipolar NPN transistors. With the configuration of the bipolar transistors as shown in FIG. 7, a self-oscillating circuit is enabled using the saturating properties the base drive transformer 1. The Q1 transistor 21 and the Q2 transistor 22 are alternately switched, under the self-oscillating function of the saturating base drive transformer 1. The base drive currents for both transistors on lines 36-1 and 36-2 are generated by secondary T_{S1} and T_{S2} transformer windings 76 and 77, through resistors 61 and 66, respectively, clamped to the emitters by diodes 62 and 67, respectively, so that Q1 transistor 21 is conducting when Q2 transistor 22 is not and vice versa. The primary T_{P} winding 75 feeding the secondary T_{S1} and T_{S2} transformer windings 76 and 77 connects at the drive node 128 connected through primary winding 75 to the line 5 input to the lamp assembly 3.

The saturating, base-drive transformer (75, 76 and 77), connected as shown in FIG. 7, establishes a self-oscillating frequency, for switching of the Q1 transistor 21 and the Q2 transistor 22 and hence the frequency of the drive voltage (for example, 50 kHz) on line 5 that drives the resonant network 33 of the fluorescent lamp assembly 3. The power stage driver circuit 36 is self-oscillating through the operation of the collector-emitter capacitor 69, the capacitor 68 and the saturating properties of base drive transformer (75, 76 and 77). The capacitor 68 connects from ground through diode 65 to the Q2 gate line 36-2 and through parallel-connected resistor 63 and anti-parallel diodes 64 to the drive node 128.

In the embodiment described, the components of FIG. 7 have the values as set forth in the following TABLE 6:

TABLE 6

| 61 | 5.1Ω | |
|---|---|---|
| 62 | HER107 | |
| 63 | 300 | kΩ |
| 64 | HER107 | |
| 65 | DB3 | |
| 66 | 5.1Ω | |
| 67 | HER107 | |
| 68 | 2.2 | nF |
| 69 | 1 | nF |

In the FIG. 7 embodiment described, the lamp assembly 3 includes the resonant network 33 which includes L2 inductor 19 connected between the primary winding 75 and the filament 10-1 and an input resistor 70 connected to line 39 from the energy recovery pump 34. The resonant network 33 also includes capacitors 73 and 74 connected between both filaments 10-1 and 10-1, respectively, on each side.

In the FIG. 7 embodiment described, the components and filaments of resonant network 33 have the values as set forth in the following TABLE 7:

TABLE 7

| 19 | 2.0 | mH |
|---|---|---|
| 70 | 300 | kΩ |
| 10-1 | 5.1Ω | |
| 10-2 | 5.1Ω | |
| 73 | 3.3 | nF |
| 74 | 2.3 | nF |

In operation of the FIG. 7 embodiment, the power stage driver 36 is self oscillating at about 50 kHz. The performance of the energy recovery pump 34 is essentially the same as in FIG. 3. The stored energy in the resonant network 33 of the lamp assembly 3 is transferred over line 6 providing an additional voltage to the energy recovery pump 34. During startup, the capacitor 73 serves as the primary load when the filaments 10-1 and 10-2 are initially cold and hence providing initial high impedance.

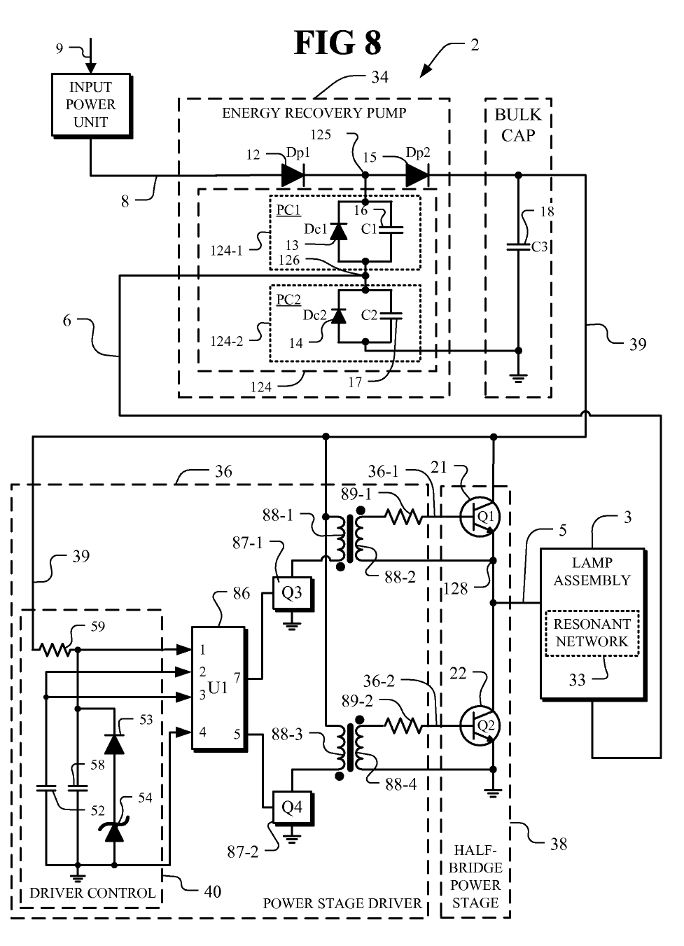

In FIG. 8, a block and circuit diagram of another embodiment of the power control unit 2 and lamp assembly 3 of FIG. 1 is shown. The power control unit 2 includes the input power unit 30 which operates to provide a filtered full-wave rectified DC voltage on line 8 of approximately 156 Vp-p.

In FIG. 8, the energy recovery pump 34 includes the Dp1 first pump diode 12, includes the Dp2 second pump diode 15, includes the pump control 124 and includes the C3 bulk capacitor 18. In the FIG. 8 embodiment, the values of the components in and the operation of the energy recovery pump 34 are typically the same as described in connection with FIG. 3.

In FIG. 8, the half-bridge power stage 38 includes Q1 drive transistor 21 and Q2 drive transistor 22 which in the present embodiment are typically MJE13003 bipolar NPN transistors. The Q1 drive transistor 21 and the Q2 drive transistor 22 are alternately switched, under control of half-bridge driver 36 through base drive signals on lines 36-1 and 36-2, respectively, from resistors 89-1 and 89-2, respectively, from the secondary windings 88-2 and 88-4, respectively, so that Q1 transistor 21 is conducting when Q2 transistor 22 is not and vice versa. The secondary windings 88-2 and 88-4 are powered by the primary windings 88-1 and 88-3, respectively, that each receive in common with the drive value on line 39 from the energy recovery pump 34. The other connection to the primary windings 88-1 and 88-3 is from the Q3 transistor switch 87-1 and the Q4 transistor switch 87-2 which are typically 2N7002 MOSFETS.

The half-bridge driver 36 determines the frequency of switching of the Q1 transistor 21 and the Q2 transistor 22 and hence the frequency of the drive voltage (for example, 50 kHz) on line 5 that drives the resonant network 33 of the fluorescent lamp assembly 3.

In FIG. 8, the half-bridge driver 36 employs the STMicro L6569 integrated circuit as the U1 integrated circuit 86. The U1 integrated circuit 86 directly controls the half-bridge power stage 38. The U1 circuit 86 has external connection pins 1, 2, . . . , 8. Connection pins 5 and 7 drive the half-bridge MOSFET Q3 and Q4 gates 87-1 and 87-2. The MOSFET Q3 and Q4 gates 87-1 and 87-2 are driven in a complementary fashion with a 1.25 μs built-in dead time to prevent cross conduction. The U1 circuit 86 includes an oscillator that potentially operates from 25 to 150 kHz with a +/−5% maximum tolerance and in the present embodiment is set to 50 kHz. The U1 circuit 86 includes a 9V Under Voltage Lock Out (UVLO) with a 1V hysteresis that requires only 150 μA at power up.

In FIG. 8, the driver control 40 provides the inputs to the U1 integrated circuit 86 on pins 1, 2, 3 and 4 and receives the line 7 input through resistor 59 from the energy recovery pump 34. The line 7 input from the energy recovery pump 34 is the output 39 from the energy recovery pump 34. The line 7 input from the energy recovery pump 34 connects through resistor 59 to the voltage input pin 1.

In FIG. 8, the driver control 40 is like that shown and described in connection with FIG. 4 and FIG. 5.

In the FIG. 8 embodiment, the lamp assembly 3 includes the resonant network 33 which is the same as the resonant network 33 in FIG. 7.

In operation of the FIG. 8 embodiment, the U1 circuit 86 provides three functions for the lamp assembly 3, namely, pre-heat, ignition, and normal lamp operation. The values of the inductive and capacitive components in the resonant circuit 33 determine the lamp ignition voltage and the nominal lamp current and in FIG. 8 have the same values as described in connection with FIG. 7.

In FIG. 8, the performance of the energy recovery pump 34 is essentially the same as in FIG. 3. The stored energy in the resonant tank of the resonant network 33 of the lamp assembly 3 is transferred to the C3 bulk capacitor 18 through the Dp2 second pump diode 15. The relative capacitance values of C1 capacitor 16 and C2 capacitor 17 are 10 times in difference and essentially all the voltage at the control node 126 is transferred to the C3 bulk capacitor 18 via the Dc1 first control diode 13.

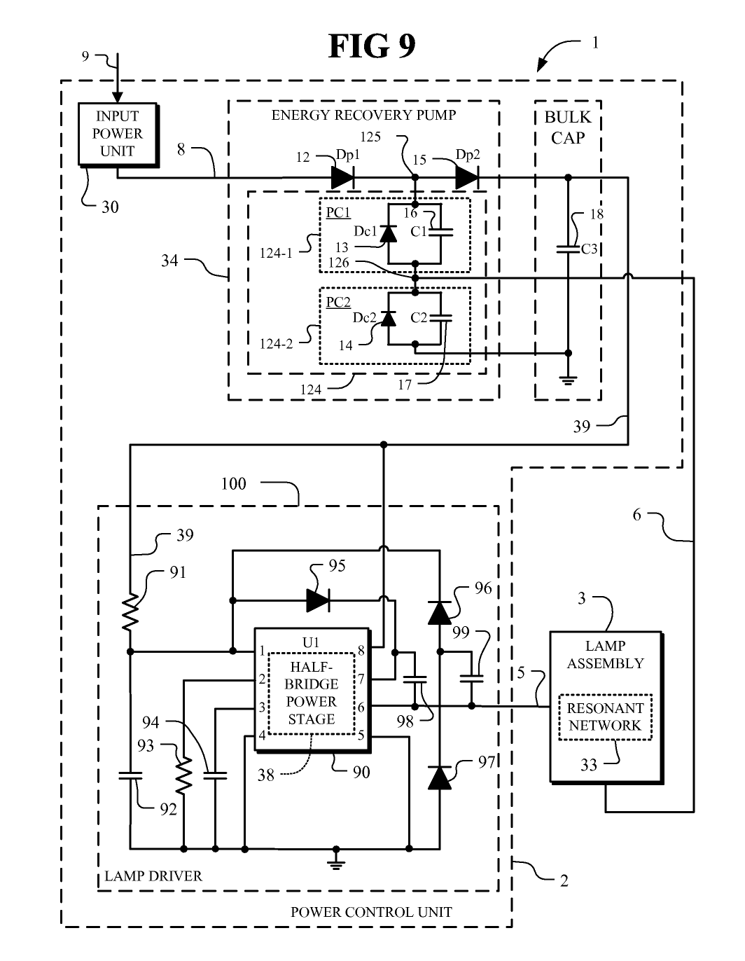

In FIG. 9, an embodiment of the fluorescent lamp 1 of FIG. 1 includes a power integrated circuit power stage driver 100, internally including a half-bridge driver and half-bridge power stage. The power control unit 2 includes the input power unit 30 which operates to provide a filtered full-wave rectified DC voltage on line 8 of approximately 156 Vp-p.

In FIG. 9, the energy recovery pump 34 includes the Dp1 first pump diode 12, the Dp2 second pump diode 15, and the pump control 124 and in addition, also includes the C3 bulk capacitor 18. In the FIG. 9 embodiment, the values of the components in and the operation of the energy recovery pump 34 are typically the same as described in connection with FIG. 3.

In FIG. 9, the lamp driver 100 employs the Fairchild FAN7710 power integrated circuit as the U1 integrated circuit 90. The U1 integrated circuit 90 is described in the publication Fairchild publication “FAN7710, Ballast Control IC for Compact Florescent Lamps” and such publication is incorporated by reference for the purpose of describing the operation of the U1 integrated circuit 90.

The U1 integrated circuit 90 pin definitions are as follows in TABLE 8:

TABLE 8

| PIN # | NAME | DESCRIPTION |
|---|---|---|
| 1 | VDD | Supply voltage |
| 2 | RT | Oscillator frequency set resistor |
| 3 | CPH | Preheating time set capacitor |
| 4 | SGND | Signal ground |
| 5 | PGND | Power ground |
| 6 | OUT | High-side floating supply return |
| 7 | VB | High-side floating supply |
| 8 | VDC | High-voltage supply |

In FIG. 9, the lamp driver 100 components provide inputs to the U1 integrated circuit 90. The line 7 input to the lamp driver 100 is the output 39 from the energy recovery pump 34. The line 7 input connects through resistor 91 to the voltage input pin 1 of U1 circuit 90.

In FIG. 9, the capacitor 92, the resistor 93 and the capacitor 94 connect to the pins 1, 2 and 3 respectively. The pins 4 and 5 connect to ground. The diode 95 connects between pins 1 and 7. The diodes 97 and 96 connect from ground in series to pin 1. The capacitor 98 connects pin 7 to pin 6. The capacitor 99 connects from the connection point of diodes 97 and 96 to the pin 6 line. In the embodiment described, the components of the lamp driver 100 have the values as set forth in the following TABLE 9:

TABLE 9

| 91 | 470 | kΩ |
|---|---|---|
| 92 | 10 | μF |
| 93 | 82 | kΩ |
| 94 | 0.68 | μF |
| 95 | UF4007 | |
| 96 | UF4007 | |
| 97 | UF4007 | |
| 98 | 100 | nF |
| 99 | 470 | pF |

In the FIG. 9 embodiment, the lamp assembly 3 includes the resonant network 33 analogous to the resonant network 33 in FIG. 7.

In operation of the FIG. 9 embodiment, the U1 circuit 90 provides four or more operation modes for the lamp assembly 3, including preheating, ignition, active and shutdown modes. The values of the inductive and capacitive components in the resonant circuit 33 determine the lamp ignition voltage and the nominal lamp current.

In FIG. 9, the performance of the energy recovery pump 34 is essentially the same as in FIG. 3. The stored energy in the resonant tank of the resonant network 33 of the lamp assembly 3 is transferred to the C3 bulk capacitor 18 through the Dp2 diode 15. The relative values of C1 capacitor 16 and C2 capacitor 17 are 10 times in difference and essentially all the voltage at the control node 126 is transferred to the bulk C3 capacitor 18 via Dc1 diode 13.

FIG. 10 depicts a 60 Hz waveform representing the 156 Vp-p input power voltage at lines 9 of FIG. 3.

FIG. 11 depicts a waveform representing the full-wave rectified nominal 156 Vp-p input power voltage on line 8 of FIG. 3.

FIG. 12 depicts a 50 kHz waveform representing the nominal 198 Vp-p drive voltage at line 5 for driving the lamp assembly 3 of FIG. 3.

FIG. 13 depicts a 50 kHz waveform representing the nominal 28 Vp-p drive voltage drop across at the filaments 10-1 and 10-2 in the lamp assembly 3 of FIG. 3.

FIG. 14 depicts a 50 kHz waveform representing the nominal 28 Vp-p additional voltage on line 6 from the lamp assembly 3 of FIG. 3 clamped to a nominal +70 Vdc by the Dc2 second control diode 14 in FIG. 3.

FIG. 15 depicts a schematic and nominal combination waveform at pump node 125 in the energy recovery pump 34 of FIG. 3. The combination waveform is derived from the 60 Hz input voltage, Vin, on line 8 combined with the 50 kHz additional voltage, Vadd, on line 6.

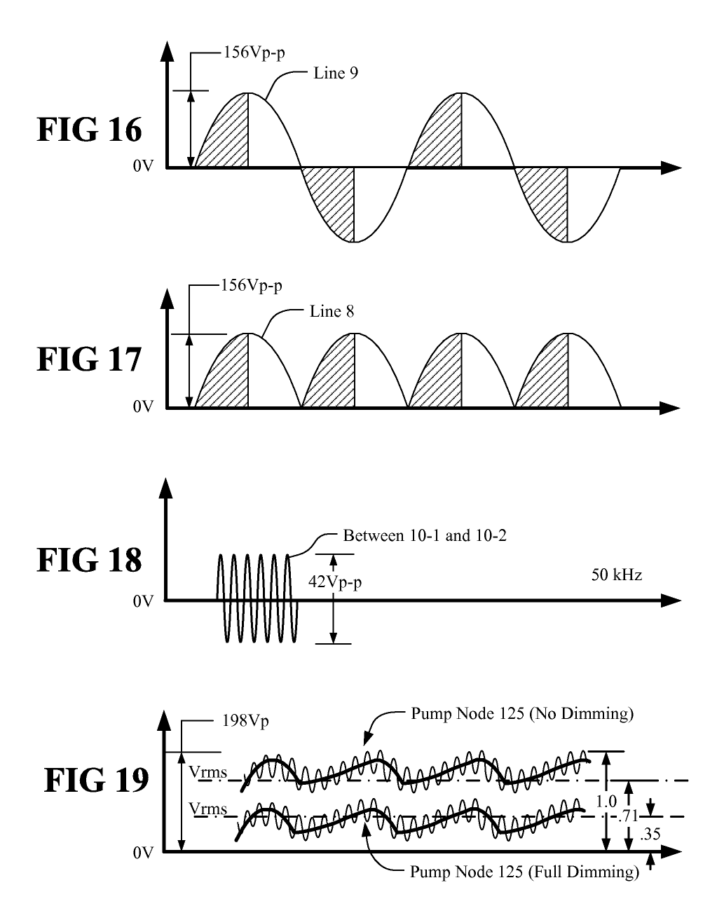

FIG. 16 depicts a waveform of a 60 Hz input voltage from a triac dimmer 101 of FIG. 7. The input voltage of FIG. 16 changes with the setting of the slide on resistor 83. In the examples described, the waveform of FIG. 16 has either no-dimming and no phase chopping (therefore including both the solid portion and the shaded portion in FIG. 16) or has full-dimming with 90 degree phase chopping (therefore including only the solid portion in FIG. 16).

FIG. 17 depicts the waveform of the voltage of FIG. 16 full-wave rectified considered with the setting on resistor 83 as either no-dimming with no phase chopping (including both the solid portion and the shaded portion in FIG. 17) or as full-dimming with 90 degree phase chopping (including only the solid portion in FIG. 17).

FIG. 18 depicts a 50 kHz waveform representing the drive voltage at the filament in the lamp assembly and the drive voltage is nominally at 28 Vp-p.

FIG. 19 depicts the nominal waveforms at the pump node 125 driven by the voltage in, Vin, represented by the nominal waveforms of FIG. 17 (one example being with no dimming with the solid portion and the shaded portion and the other example being with full dimming with the solid portion only) combined with a 50 kHz derived waveform for both the no-dimming (with no phase chopping) example and the full-dimming (with 90 degree phase chopping) example. In the no dimming example, the pump node 125 voltage in the energy recovery pump 34 of FIG. 7 (see energy recovery pump 34 of FIG. 3 for details) nominally has a peak voltage of 198 Vp with an Vrms value of about 141 Vrms (0.71 times 198 Vp). For the full-dimming example, the nominal voltage is 69 Vrms (0.35 times 198 Vp).

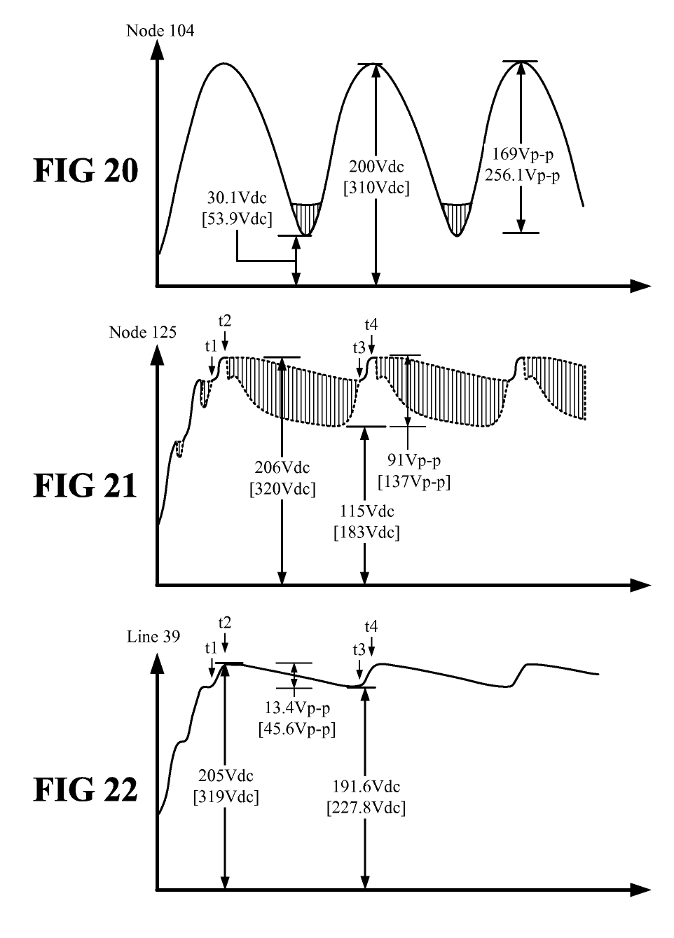

In FIG. 20, an actual input voltage, Vin, as it appears at node 104 in the input unit 30 in FIG. 3 is shown. In the examples described, the input line voltages on lines 9 from the power source 101 of FIG. 1 are give for 140 Vrms without brackets and the values in brackets are for [220 Vrms]. The peak voltage is about 200 Vdc [310 Vdc] and the minimum voltage is about 30.1 Vdc [53.9 Vdc] for a peak-to-peak of 169 Vp-p [256.1 Vp-p]. The minimum voltage 30.1 Vdc [53.9 Vdc] is above ground because the input power unit sees a reactive input impedance looking into the energy recovery pump 34 primarily due to the C3 bulk capacitor 18.

In FIG. 21, an actual combination voltage, Vcomb, at pump node 125 in FIG. 3 is shown. The values are given for 140 Vrms without brackets and for 220 Vrms in brackets. The time prior to time t1, is a startup period. Between times t1 and t2, the peak of the Vin waveform of FIG. 20 is being reached and the Vcomb rises to about 206 Vdc with the Dp1 first pump element 12 and the Dp2 second pump element 15 (see FIG. 3, for example) conducting to charge the C3 bulk capacitor 18. At about time t2, the Vin waveform of FIG. 20 is beginning to fall and the hence the Dp1 first pump element 12 is first turned OFF and the 50 KHz Vadd voltage becomes controlling. The 50 KHz Vadd voltage remains controlling until about time t3. Between times t3 and t4, the peak of the Vin waveform of FIG. 20 is again being reached and hence the Dp1 first pump element 12 remains turned ON. After time t4, the cycle repeats again and again the same as between times t2 and t4.

In FIG. 22, the voltage on output line 39 from the energy recovery pump 34 (see FIG. 3, for example) is shown. The voltage on output line 39 is the voltage on the C3 bulk capacitor 18 and is the dc value of the combination voltage, Vcomb, at pump node 125. Therefore, the voltage on output line 39 is also referred to as the combination voltage, Vcomb. In FIG. 22, the waveform of Vcomp closely follows the peak value of the waveform in FIG. 21. For one cycle between times t2 and t4, a peak of 205 Vdc [319 Vdc] falls to a low of 191.6 Vdc [227.8 Vdc] for a difference of 13.4 Vp-p [45.6 Vp-p].

The FIG. 20, FIG. 21 and FIG. 22 waveforms depict the actual operation of particular embodiments of the energy recovery pump 34. The schematic and nominal descriptions of the operation in connection with FIG. 10 through FIG. 19 should be interpreted in light of the FIG. 20, FIG. 21 and FIG. 22 actual operation and equivalents thereof.

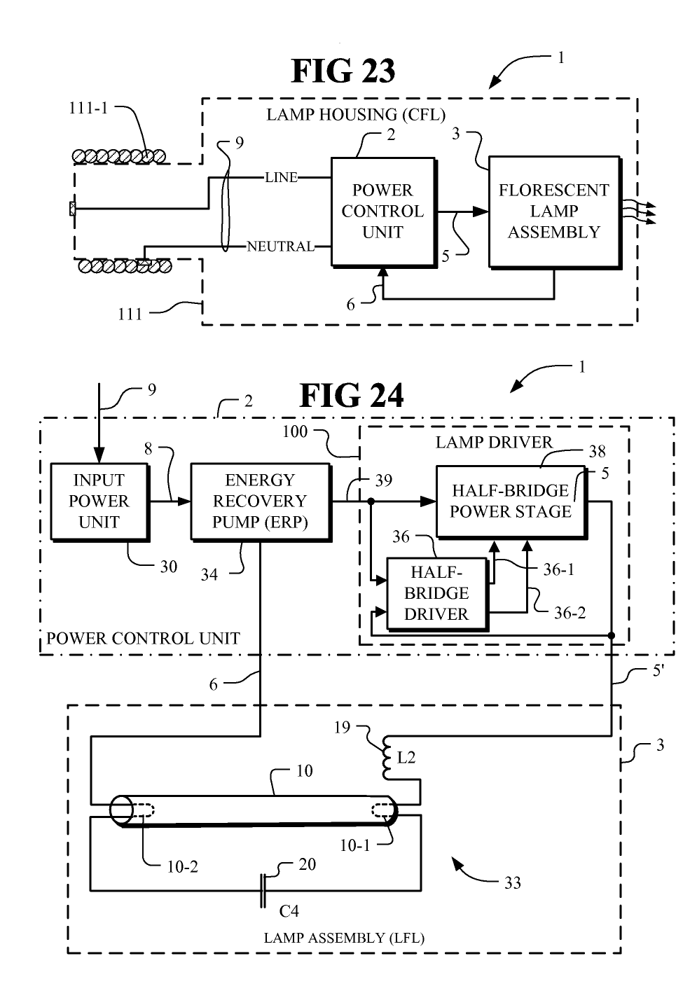

In FIG. 23, the fluorescent lamp 1 of FIG. 1 is contained within a compact housing 111 having an Edison-type base 111-1 for engaging conventional Edison light sockets. The lamp housing 111 in FIG. 23 is schematic and is presented to indicate that the physical size of the florescent lamp 100 can be approximately the same as or smaller than the physical sizes of similar conventional 75 watt or 100 watt incandescent light bulbs with Edison-type bases or any other type of bases. Fluorescent lamps of the present invention can be used for any size or shape fluorescent lights including Long Fluorescent Lamps (LFLs) and Compact Fluorescent Lamps over a wide range of light output of which 1100 μm and 1600 μm are only representative of popular light bulbs.

In FIG. 24, the fluorescent lamp 1 includes a power control unit 2 and a fluorescent lamp assembly 3. The power control unit 2 includes an input power unit 30, an energy recovery pump 34 and a half-bridge driver, 36 including a half-bridge power stage, 38. The fluorescent lamp assembly 3 includes a resonant network 33.

In the power control unit 2 of FIG. 24, the input power unit 30 receives low-frequency AC power on lines 9, for example, typically a 110 or 220 volts (RMS), 60 Hz sinusoidal line voltage in the United States (or different voltage levels in the United States and other countries of the world). The input power unit 30 operates to receive the input on lines 9 of nominally 311 Vpeak for a 220 Vrms to provide a full-wave rectified voltage on line 8 of about nominally 311 Vp-p subsequently converted to a DC level of about 311 Vdc that is stored in the energy recovery pump 34.

In FIG. 24, the energy recovery pump 34 pumps the rectified voltage on line 8 to a voltage on line 39 of about 319 Vdc. The energy recovery pump 34 receives, in addition to the low-frequency-derived voltage on line 8 from the input power unit 30, an additional voltage on line 6 from the resonant network 33 of fluorescent lamp assembly 3 (or alternatively from other sources). The additional voltage on line 6 significantly improves the power efficiency and the power factor of the fluorescent lamp 1.

In FIG. 24, the half-bridge power stage 38 switches the voltage on line 39 to form an AC high-frequency (for example, 50 kHz) drive voltage of about 319 Vp on line 5, see FIG. 22, to drive the fluorescent lamp assembly 3. The half-bridge power stage 38 is controlled by the half-bridge driver 36. The half-bridge driver 36 receives an input from energy recovery pump 34 on line 39 and on receives an input from line 5 to provide control inputs to half-bridge power stage 38 on lines 36-1 and 36-2.

The drive voltage of about 319 Vp on line 5 is sufficient, in the example described, to drive a conventional four-foot, 40-watt lamp assembly.

While the invention has been particularly shown and described with reference to preferred embodiments thereof it will be understood by those skilled in the art that various changes in form and details may be made therein without departing from the scope of the invention.

1. A fluorescent lamp comprising,
a lamp assembly including a fluorescent tube having filaments and including a resonant network, having resonant inductance and resonant capacitance values, connected to the filaments for resonant operation,
a power control unit for driving the lamp assembly, the power control unit including,
an input power unit for providing an input voltage,
a bulk capacitor for storing a high DC voltage,
a lamp driver for switching the high DC voltage with a high switching frequency to provide a high-frequency driving voltage for driving the resonant network,
a source for providing an additional voltage,
an energy recovery pump combining the input voltage and the additional voltage to form the high DC voltage, said energy recovery pump balanced so as not to disturb the resonant operation of the resonant network and so as to enable transfer of energy to the bulk capacitor to provide a high luminous efficiency for the fluorescent lamp.

2. The fluorescent lamp of claim 1 wherein the additional voltage is connected as a high-frequency voltage from the resonant network.

3. The fluorescent lamp of claim 1 wherein the energy recovery pump includes,
a first pump element for unidirectional conduction of an input current in response to the input voltage,
a second pump element connected at a pump node with the first pump element for unidirectional conduction of a charging current to charge the bulk capacitor,
a pump control for connecting the additional voltage to the pump node to cause an input current to conduct through the first pump element and the second pump element to charge the bulk capacitor when the input voltage is greater than a voltage threshold and to cause the first element to be non-conducting and to cause an additional current to conduct through the second pump element to charge the bulk capacitor when the input voltage is less than the voltage threshold.

4. The fluorescent lamp of claim 3 wherein the pump control comprises,
a first pump control element including a first unidirectional control element and a first capacitor connected between a control node and the pump node,
a second pump control element including a second unidirectional control element and a second capacitor connected between the control node and the pump node,
and wherein the additional voltage is connected at the control node.

5. The fluorescent lamp of claim 4 wherein the first pump element, the second pump element, the first unidirectional control element and the second unidirectional control element are diodes.

6. The fluorescent lamp of claim 4 wherein the first pump element, the second pump element, the first unidirectional control element and the second unidirectional control element are MOSFETS.

7. The fluorescent lamp of claim 4 wherein the first capacitor has a value that is more than about ten times greater than a value of the second capacitor and wherein the value of the second capacitor is about five times greater than the resonant capacitance value.

8. The fluorescent lamp of claim 1 wherein the lamp driver includes a half-bridge power stage for switching the high DC voltage and a power stage driver providing the high switching frequency to the half-bridge power stage.

9. The fluorescent lamp of claim 10 wherein the power stage driver includes an integrated circuit driver for driving the half-bridge power stage in multiple power modes including a start-up mode and a steady-state mode.

10. The fluorescent lamp of claim 8 wherein the half-bridge power stage includes a first drive transistor and a second drive transistor connected at a drive node and connected in series between the bulk capacitor and a reference level where the power stage driver alternately switches the first transistor and the second transistor ON and OFF whereby the first transistor is ON when the second transistor is OFF and whereby the first transistor is OFF when the second transistor is ON and where said drive node connects to the resonant network to drive the lamp assembly.

11. The fluorescent lamp of claim 10 wherein the first drive transistor and the second drive transistor are MOSFET transistors having source-to-drain connections in series and wherein the power stage driver is an integrated circuit having first and second outputs connected to gates of the first drive transistor and the second drive transistor, respectively, for controlling the ON and OFF switching of the first drive transistor and the second drive transistor.

12. The fluorescent lamp of claim 1 wherein the lamp driver includes a half-bridge power stage for switching the high DC voltage and a half-bridge driver providing the high switching frequency to the half-bridge power stage and wherein the half-bridge power stage and the half-bridge driver are an integrated circuit on a common substrate.

13. A fluorescent lamp comprising,
a lamp assembly including a fluorescent tube having filaments and including a resonant network, having resonant inductance and resonant capacitance values, connected to the filaments for resonant operation,
a power control unit for driving the lamp assembly, the power control unit including,
an input power unit for providing an input voltage,
a bulk capacitor for storing a high DC voltage,
a lamp driver for switching the high DC voltage with a high switching frequency to provide a high-frequency driving voltage for driving the resonant network,
a connection from the resonant network for providing an additional voltage,
an energy recovery pump combining the input voltage and the additional voltage to form the high DC voltage, said energy recovery pump balanced so as not to disturb the resonant operation of the resonant network and so as to enable transfer of energy to the bulk capacitor to provide a high luminous efficiency for the fluorescent lamp and wherein the energy recovery pump includes,
a first pump element for unidirectional conduction of an input current in response to the input voltage,
a second pump element connected at a pump node with the first pump element for unidirectional conduction of a charging current to charge the bulk capacitor,
a pump control for connecting the additional voltage to the pump node to cause an input current to conduct through the first pump element and the second pump element to charge the bulk capacitor when the input voltage is greater than a voltage threshold and to cause the first element to be non-conducting and to cause an additional current to conduct through the second pump element to charge the bulk capacitor when the input voltage is less than the voltage threshold and wherein the pump control comprises,
a first pump control element including a first diode control element and a first capacitor connected between a control node and the pump node,
a second pump control element including a second diode control element and a second capacitor connected between the control node and the pump node,
and wherein the additional voltage is connected at the control node.

14. The fluorescent lamp of claim 13 wherein the first capacitor has a value that is more than about ten times greater than a value of the second capacitor and wherein the value of the second capacitor is about five times greater than the resonant capacitance value.

15. The fluorescent lamp of claim 13 wherein the lamp driver includes a half-bridge power stage for switching the high DC voltage and a power stage driver providing the high switching frequency to the half-bridge power stage.

16. The fluorescent lamp of claim 15 wherein the power stage driver includes an integrated circuit driver for driving the half-bridge power stage in multiple power modes including a start-up mode and a steady-state mode.

17. The fluorescent lamp of claim 15 wherein the half-bridge power stage includes a first drive transistor and a second drive transistor connected at a drive node and connected in series between the bulk capacitor and a reference level where the power stage driver alternately switches the first transistor and the second transistor ON and OFF whereby the first transistor is ON when the second transistor is OFF and whereby the first transistor is OFF when the second transistor is ON and where said drive node connects to the resonant network to drive the lamp assembly.

18. The fluorescent lamp of claim 17 wherein the first drive transistor and the second drive transistor are MOSFET transistors having source-to-drain connections in series and wherein the power stage driver is an integrated circuit having first and second outputs connected to gates of the first drive transistor and the second drive transistor, respectively, for controlling the ON and OFF switching of the first drive transistor and the second drive transistor.

19. The fluorescent lamp of claim 1 wherein the lamp driver includes a half-bridge power stage for switching the high DC voltage and a half-bridge driver providing the high switching frequency to the half-bridge power stage and wherein the half-bridge power stage and the half-bridge driver are an integrated circuit on a common substrate.
